(19) United States
(12) Patent Application Publication
(10) Pub. No.: US 2011/0177310 A1
(43) Pub. Date: Jul. 21, 2011

(54) Projectile Resistant Transparent Laminate

(76) Inventors: Ione Battilla Ryan, Houston, TX (US); Craig Scott Mears, Grapevine, TX (US)

(21) Appl. No.: 12/690,588

(22) Filed: Jan. 20, 2010

(51) Int. Cl. B32B 27/40; B32B 27/06; B32B 17/10; B32B 27/36

(52) U.S. Cl. 428/213; 428/423.1; 428/339; 428/425.6; 428/412

(57) ABSTRACT

A projectile-resistant transparent laminate comprises a rigid laminate assembly having a strike side surface opposing a direction of an anticipated threat, and includes first and second rigid transparent lamina bonded together with a transparent, ether-based thermoplastic elastomer layer interposed therebetween, where the thermoplastic elastomer layer further includes a transparent polyurethane having an ultra-high modulus of elasticity. The projectile-resistant laminate also includes an energy absorbing layer including a transparent, quasi-thermoset layer from a cast aliphatic urethane bonded to the rigid laminate assembly.

### BACKGROUND

1. Field

The present invention relates generally to transparent laminate structures for use in safety and security applications. Particularly, this invention relates to transparent laminate structures and a method of making same using an ultra-high modulus thermo-plastic elastomer as a stabilizer of rigid substrates, and a energy absorbing layer, and further, to transparent laminate structures formed from combinations of one of two modules, where one module includes a rigid laminate structure stabilized by an ultra-high modulus thermo-plastic elastomer, and a second module includes a energy absorbing layer.

2. Description of the Problem and Related Art

Impact resistant glass laminates were first introduced in the early 1900s and are well known in the art today for use in safety and security glass applications, and have been traditionally constructed using alternating layers of glass and plastic sheeting in the form of thermosets, or thermoplastics with adhesive and or heat bonding interlays. For example, bullet resistant glass is sometimes constructed with several glass sheets connected together with thin sheets of polyvinyl butyral, or polyester interposed there between with a polycarbonate layer bonded on the inside face of the final glass sheet using a thermoplastic polyurethane layer. The polycarbonate layer provides additional strength, and to a small degree, elasticity, to the glass upon impact but is used primarily to provide good resistance to spalling.

However, excessive layering of glass and polycarbonate sheets creates problems. First, using such materials, the weight and thickness of the transparent laminar assembly requires a heavily engineered and reinforced support structure. Next, such laminar assemblies suffer delamination in the presence of heat, either localized heat from high-velocity projectile, heat from the bonding process, or ambient heat from, for example, desert environments. Additionally, current transparent laminar structures also suffer from other safety concerns such as leaching of biphenyl “A′s”. Such characteristics decrease life cycle of the systems and structural stability, ultimately reducing or negating their effectiveness.

Other materials such as aromatics and ether-based have exhibited a great resistance to heat, and can provide desirable mechanical properties of greater elasticity and lighter weight. However, heretofore, such compositions have not been suitable for use in transparent armor because over time light transmissiveness degrades.

### SUMMARY

The present disclosure is directed to a transparent projectile-resistant laminate assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

It should also be noted that the term “projectile” may refer to any object that may strike the surface of a transparent assembly and cause degradation or failure. These may include projectiles such as bullets, shrapnel, thrown objects such as bricks, stones and other similar objects and self-propelled items such as RPG's, IED's, missiles, and other rocket like projectiles. Projectiles may also include objects that become self-propelled by an Act of God or nature as a result of severe weather conditions such as tornadoes, hurricanes, sand storms, typhoons and high winds. Projectiles may also include objects used to directly strike the surface of the assembly such as bats, bricks, metal objects, wooden clubs, etc. Projectiles may also include objects that come into contact with the transparent assembly if used in a vehicle and that vehicle was to become part of an accident or intentional hazard.

A projectile-resistant transparent laminate includes a rigid laminate assembly with first and second rigid transparent lamina bonded together with a transparent, ether-based thermoplastic elastomer layer interposed therebetween. The thermoplastic elastomer layer includes a transparent polyurethane having an ultra-high modulus of elasticity. The laminate also includes an energy absorbing assembly that includes a transparent, quasi-thermoset layer from a cast aliphatic urethane.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

The present invention is described with reference to the accompanying drawings. In the drawings, like reference numbers indicate identical or functionally similar elements. Additionally, the left-most digit(s) of a reference number identifies the drawing in which the reference number first appears.

FIG. 1 is a sectional view of a rigid laminate assembly;

FIG. 2 is a sectional view of a transparent armor structure incorporating the rigid laminate assembly illustrated in FIG. 1; and

FIGS. 3 through 8 are sectional views of other exemplary embodiments of a transparent armor structure, each incorporating a rigid laminate assembly and an energy absorbing layer; and

FIG. 9 is a perspective view a projectile resistant laminate assembly according to yet another embodiment; and

FIG. 10 illustrates an interlayer frame for use in one embodiment; and

FIG. 11 is a section view of an exemplary laminate assembly illustrating incorporation of the interlayer frame of FIG. 10.

### DETAILED DESCRIPTION

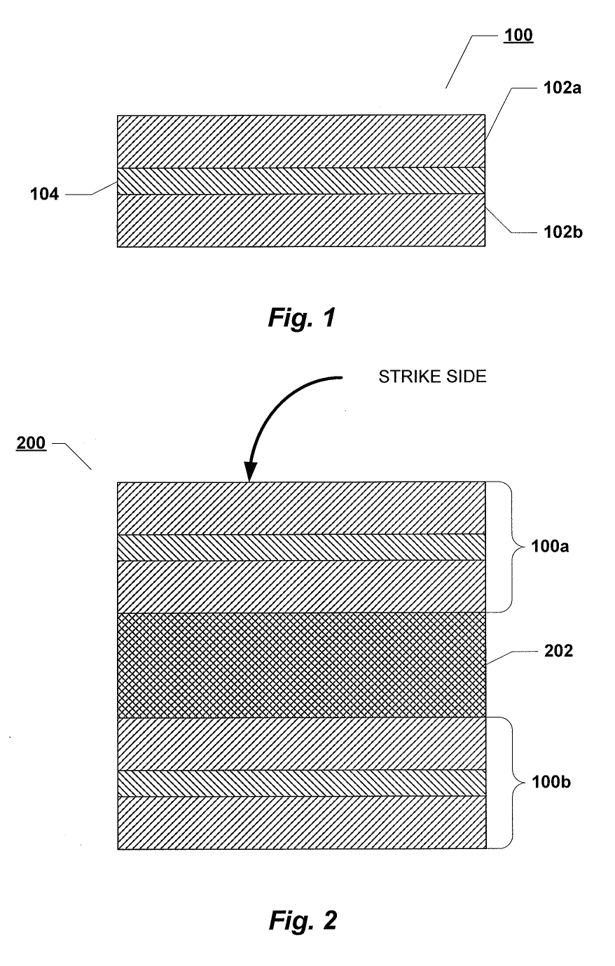

The various embodiments of the present invention and their advantages are best understood by referring to FIGS. 1 through 9 of the drawings. The elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described above are to be considered in all aspects as illustrative only and not restrictive in any manner.

The following claims rather than the foregoing description indicate the scope of the invention.

Referring to the drawings, FIG. 1 depicts a rigid laminate assembly 100 comprising a first layer of a rigid, transparent material 102a, a second layer of a rigid, transparent material 102b, in between which is a transparent thermoplastic elastomer layer 104 of an ultra-high modulus, super elastic shape memory thermoplastic polyurethane that bonds the two rigid layers 102 together. First and second layers 102 should generally be of equal thickness. A laminate assembly 100 thickness of between about 0.093 inches to about 0.375 inches is sufficient for most applications; however, it is to be understood that the thicknesses of the components could be varied to suit the anticipated threat and installation design. Additionally, first and second rigid transparent layers 102 could be a glass, preferably annealed to increase its strength. A prototype embodying the principles described herein was achieved with the “STARPHIRE®” glass product sold by PPG Industries, Inc., of Pittsburgh, Pa. When borosilicate glass or the soda lime glass is used in this invention, it is preferable to chemically or thermally reinforce the glass in order to improve the impact resistance. Rigid, transparent layer 102 could also be a transparent polycarbonate.

The thermoplastic elastomer layer 104 is an ultra-high modulus thermoplastic elastomer (“UHMTPE”) having super elastic shape memory. These characteristics are achieved with an aromatic polyether-based, rather than ester-based, thermoplastic, long-molecular chain, polyurethane, at about 96% by weight, and about 4% by weight of a stabilizer composition that includes an anti-oxidant and a light stabilizer. Those skilled in the relevant arts with the benefit of this disclosure will recognize that heretofore, ether-based polymers have not been used in glass and polycarbonate laminations. This is because they breakdown in the presence of heat from the lamination process and from the environment. However, the inventors hereof have discovered the use of certain stabilizers counters these deleterious effects. Specifically, the anti-oxidant prevents thermally induced oxidation of polymers during coating and heat lamination, traps free radicals formed during heating in the presence of oxygen and prevents discoloration and change of mechanical properties incumbent to the polymer. In other words, mechanical properties such as elasticity, and light transmissiveness are maintained even in the presence of heat. An example of such anti-oxidant is a phenolic stabilizer offered by Ciba Specialty Chemical Corporation, Tarrytown, N.Y., under the trademark Irganox®.

The light stabilizer includes an ultra violet (UV) absorber and a hindered amine light stabilizer (HALS). The UV absorber filters harmful UV light and prevents discoloration that degrades light transmission and prevents delamination when heating. HALS also trap free radicals formed under heat and are primarily useful in maintaining surface properties such as gloss. HALS also prevents cracking and chalking of the polymer. When used together, they have a complimentary synergistic effect. One such light stabilizer is offered under the mark Tinuvin®, also by Ciba.

A suitable polyether-based thermoplastic polyurethane with such heat resistance, and light preservation as described above can be obtained as “VT-0124,” offered by MBM Technologies, of Houston, Tex. The thermoplastic elastomer is applied as a film and can be between about 3 mils to about 10 mils in thickness. This layer increases the elasticity of the glass layers and substantially reduces the area of local gross deformation of the laminate assembly 100 at the point of impact. The laminate assembly is assembled by a conventional autoclave process using iterative application of heat (e.g., up to about 360° F.) and pressure (e.g., up to about 60 psi).

Preferably, all bonded surfaces of the rigid layers 102a, b to which the thermoplastic elastomer layer is to be bonded are cleaned before the bonding process with a bonding and cleaning agent. A preferred bonding and cleaning agent is a silane-based solution comprising an organofunctional silane to facilitate the bonding of the inorganic glass to the organic thermoplastic layer, an alcohol to act as a solvent, and a silicone glycol copolymer that acts as a wetting and leveling compound. Further, the solution may be diluted with water, preferably de-ionized water. An example of a suitable bonding and cleaning agent is known as XO Bond™, offered by XO Armor, LLP of Houston, Tex.

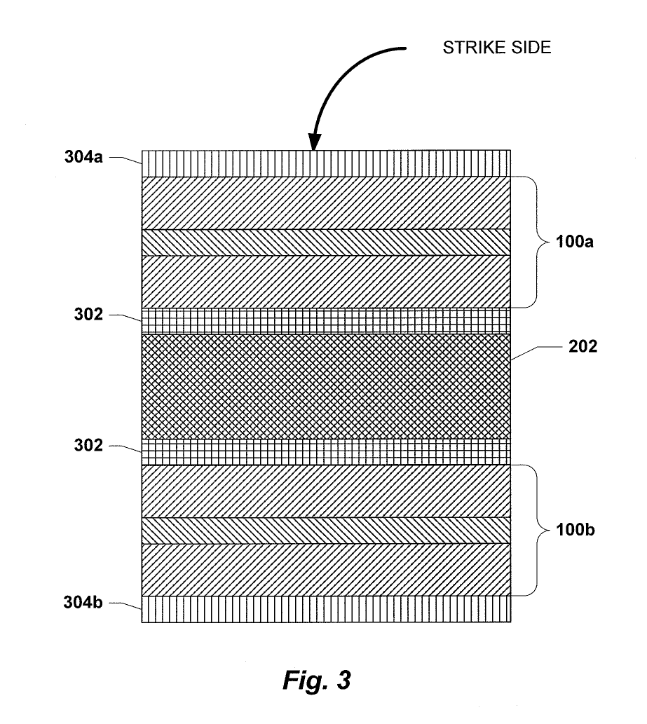

Transparent armor of this disclosure includes in a variety of combinations using the above described rigid laminate assembly 100, and a backing energy distribution layer consisting of a cast quasi-thermoset. For example, a first embodiment of a transparent armor 200 is disclosed with reference to FIG. 2 where a first rigid laminate assembly 100a is bonded to a layer of cast optical grade quasi-thermoset 202 which is bonded to a second rigid laminate assembly 100b. The energy absorbing layer 202 may be between about 0.25 inches to about 0.5 inches thick, depending upon the anticipated threat. The quasi-thermoset material is a cast aliphatic urethane. Unlike true thermoset materials, this quasi-thermoset exhibits thermoplastic characteristics as far as flow, elasticity and “self healing” shape memory.

The above-described laminate demonstrates extraordinary strength when loaded by energies associated with rigid body impactors, while resulting in a structure that is thinner and lighter than current transparent armors. At the same time, optical quality of the laminate is only minimally degraded, if at all.

During an impact event, a projectile strikes the strike face of the structure, impacting first the rigid laminate assembly 100. In essence, the rigid laminate assembly 100 acts to strip a projectile jacket, and dissipate kinetic energy. It also begins erosion and/or ablation of the projectile tip that further slows the projectile's velocity. The described ultra high modulus properties of the polyether-based thermoplastic elastomer provide stability to the rigid layers, and increases to some degree their elasticity, allowing the rigid layers 102 to bend significantly under impact loads without breaking. The polyether-based thermoplastic elastomer layer 104 also increases material interface between the rigid layers and allows for local impact energies to be dispersed and dissipated over a greater surface area thereby improving management of the impact event. This is a result of super elastic shape memory provided by the extremely long molecular chain associated with the polymer and is measured at a 27 in accordance with measurements contained in the ASTM D790. Therefore, substrate stability, superior optical qualities, and ability to withstand temperatures in excess of 200 degrees C. make the material unique and optimum for superior performance of this application.

Once the projectile travels through the rigid laminate assembly 100 it encounters the energy absorbing layer 202. Since the energy absorbing layer comprises a quasi-thermoset, it softens in response to the addition of heat, and exhibits elasticity and shape memory of a thermoplastic. As the projectile penetrates the energy absorbing layer 202, its energy is further dissipated, especially since the projectile tip has been blunted by its encounter with the rigid laminate assembly.

A further embodiment is illustrated in FIG. 3 where a first rigid laminate assembly 100a has an optical film layer 304a bonded to the outer surface thereof facing the direction from where the projectile might come, or the “strike side” indicated by the reference arrow. The optical film layer 304a is applied to a first rigid laminate assembly 100a. Again, a energy absorbing layer 202 is placed behind the first laminate assembly 100a, and ahead of a second rigid laminate assembly 100b, in between which are respective layers of an interlayer bonding material 302.

A second optical film layer 304b is bonded to the non-strike side surface of the second rigid laminate assembly 100b. Each optical film layer 304 may be comprised of two or more layers of a film, each of which may be a transparent polyethylene terephthalate (PET) and may be between about 0.11 mils and about 0.21 mils in thickness. Interlayer bonding material 302 may be between about 0.015 and about 0.050 inches and comprise another, secondary thermoplastic elastomer layer, to bond the rigid laminate assemblies 100 to either surface of the energy absorbing layer 202. In the alternative, interlayer material 302 may also be an aliphatic thermoplastic polyurethane film. Suitable materials include the above-described VT-0124, or the A4700 produced by Deerfield Urethane, of South Deerfield, Mass., or the Texstars 851, 1451 from Texstars, Inc., of Houston, Tex. Each of the layers may be bonded in a manner similar to that used for the rigid laminate assembly.

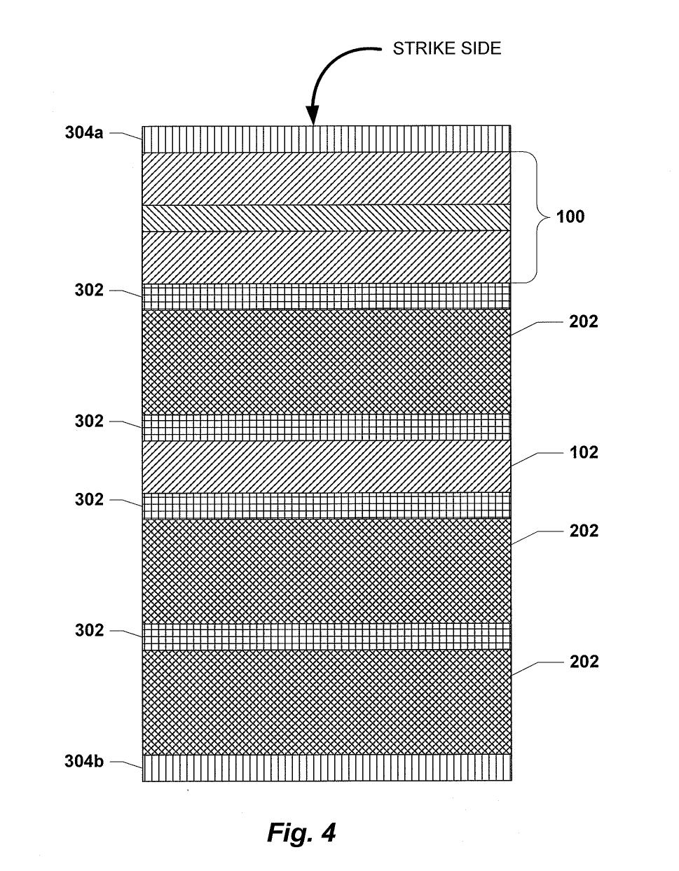

With reference now to FIG. 4, a further embodiment includes a first film layer 304a bonded to the strike side of a rigid laminate assembly 100. Again an energy absorbing layer 202 is bonded to the opposing side of the rigid laminate assembly 100 and to which is bonded on its opposing side a rigid, transparent layer 102. This is followed by two more layers of quasi-thermoset 202. Each of these layers are interleaved with layers of interlayer bonding material 302. Finally, the interior surface includes a second film layer 304b.

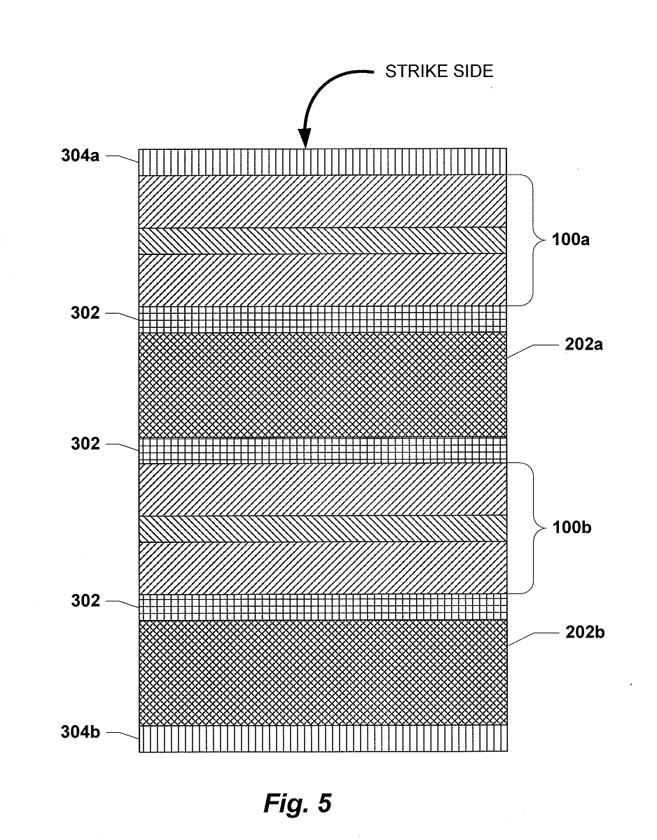

FIG. 5 illustrates a further embodiment wherein a first film layer 304a is bonded to the strike side surface of a first rigid laminate assembly 100a which is bonded to a first energy absorbing layer 202a with an interlayer bonding material 302 interposed therebetween. A second rigid laminate assembly 100b is bonded to the opposing side of the first energy absorbing layer 100a, again with an interlayer bonding material 302, and a second energy absorbing layer 202b is bonded to the opposing side of the second rigid laminate assembly 100b with another interlayer bonding material 302. Again, the interior surface of the transparent armor is overlaid with a second film layer 304b.

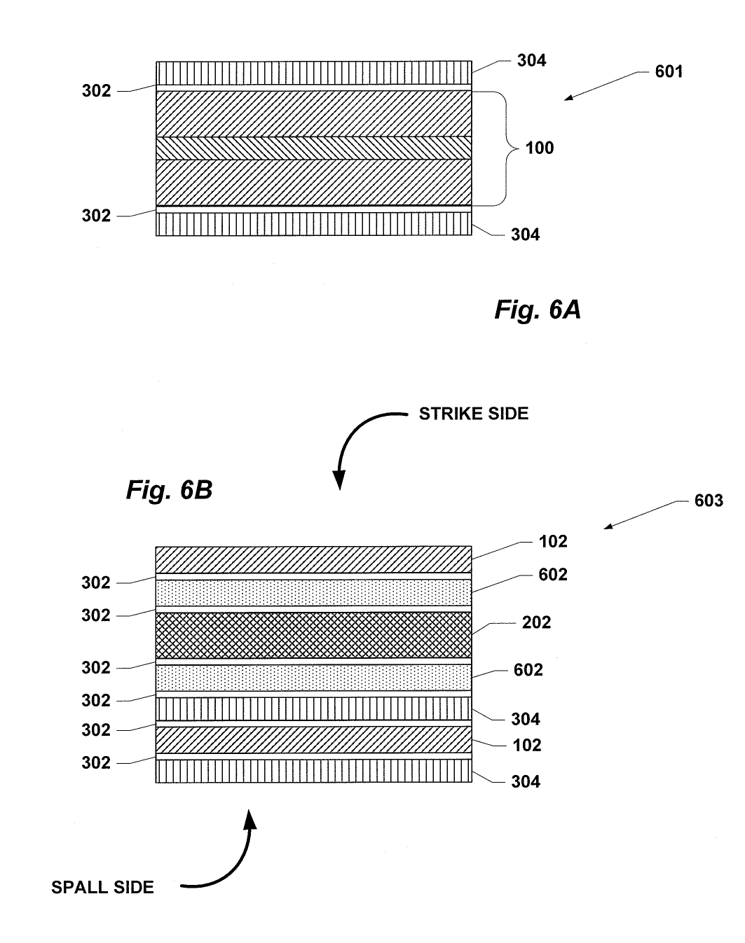

energy absorbing layerenergy absorbing layerenergy absorbing layerA further embodiment using components and principals described above is shown in FIG. 6A, 6B where a rigid module 601 is provided. Rigid module 601 is comprised of the rigid laminate assembly 100, sandwiched between two layers of optical film 304, with layers of interlayer bonding material 302 interposed therebetween. A “flex” module 603 is illustrated in FIG. 6B where in the energy absorbing layer 202 is sandwiched between sheets of polycarbonate 602 which may be between about 0.093 inches and about 0.325 inches in thickness, and bonded with respective layers of interlayer bonding material 302. In addition, toward the strike side, a layer of glass is bonded to polycarbonate layer 602 with interlayer material 302, while on the inner side, a layer of glass sandwiched between two layers of optical film 304, and bonded with interlayer material 302 to the inward surface of the inner polycarbonate layer 602.

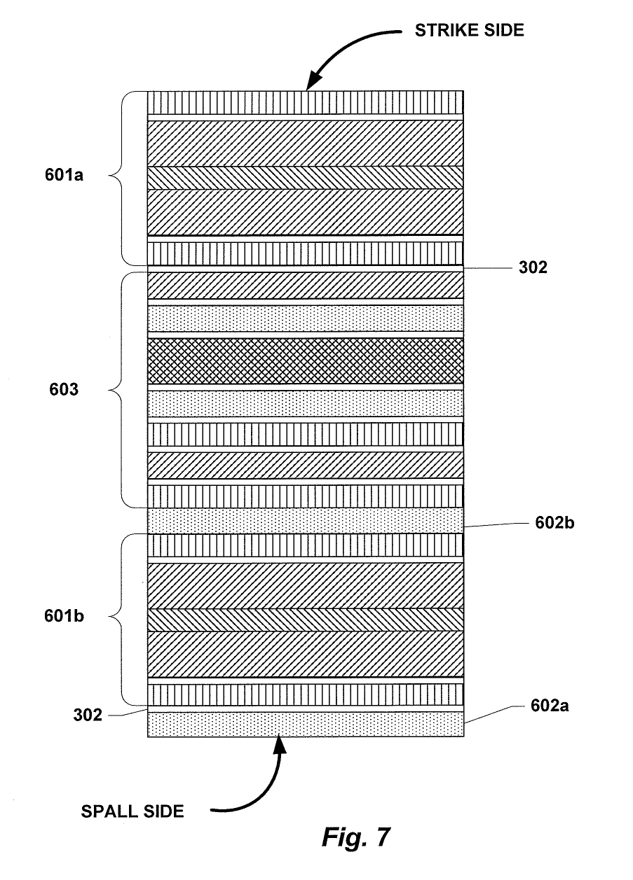

FIG. 7 shows an example of combining a rigid module 601 with a flex module 603 to achieve another embodiment of a transparent armor laminate. The laminate 700 includes a strike side (indicated by reference arrow) and a spall side (also indicated by reference arrow), This version employs a first rigid module 601a facing the strike side, bonded to a flex module 603 with a layer of interlayer bonding material 302. A second rigid module 601b is stacked toward the spall side of the flex module 603. For bullet-resistant transparent laminate applications, regulations, may require a layer of polycarbonate 602a on the spall side to further mitigate splintering.

It may be advantageous to interpose a second polycarbonate layer 602b between the flex module and the 601b without bonding. The inventors herein have discovered in prototype testing that the layering of different materials presents a projectile penetrating the laminate with layers varying in density, rigidity, and elasticity. Each time the projectile encounters a different material, its path alters somewhat, slowing its velocity. The lack of bonding between the intermediate polycarbonate layer 602b and the flex module 603 and the second rigid module 601b results in an air gap on the order of microns in thickness which serves as yet a different medium through which the projectile passes and turns yet again.

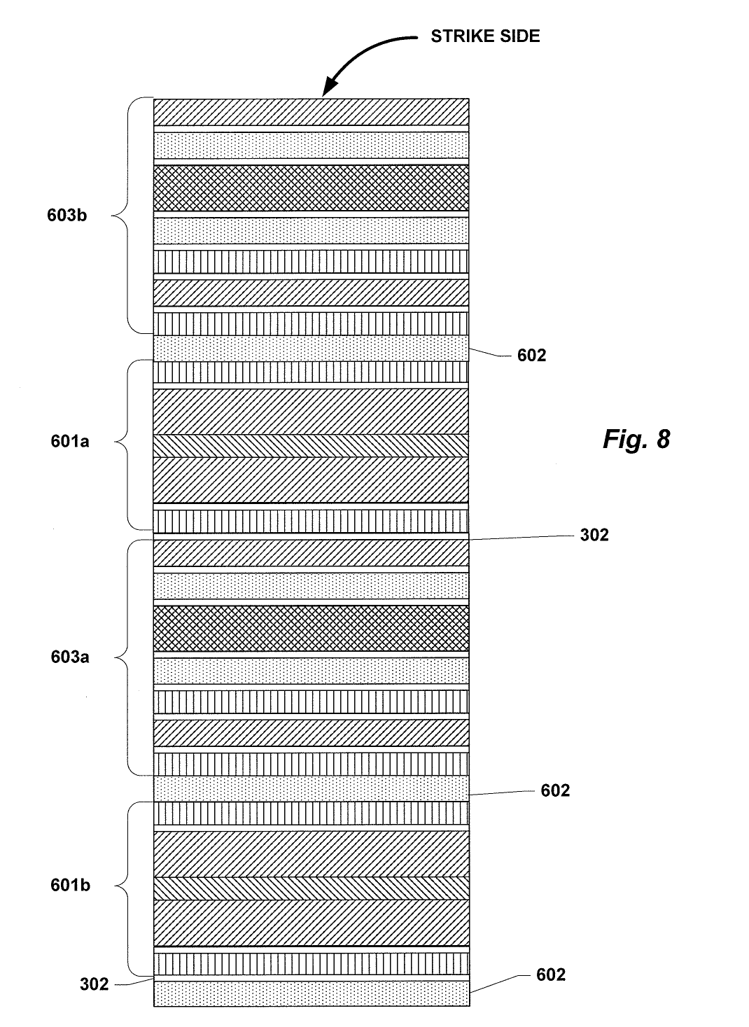

FIG. 8 shows a further embodiment wherein the laminate of FIG. 7 is appended with a second flex module 603b toward the strike side. Again, between the second flex module 603b and the first rigid module 601a a layer of polycarbonate 602 may be placed as shown, and may be used without bonding material.

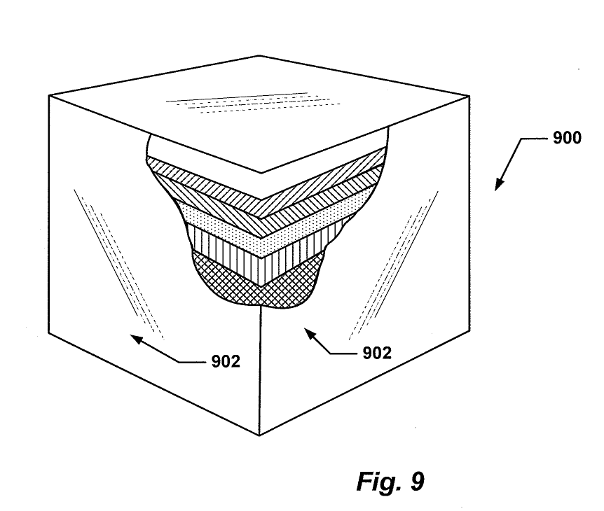

FIG. 9 illustrates yet another embodiment of the transparent armor laminate 900 wherein the layers are arranged as described above. In this drawing, however, the fill patterns do not correspond with the fill patterns used in previous drawings to indicate a specific material, but are only used in this FIG. 9 to represent different layers. This embodiment employs and edge bonding 902 that can be the same bonding material used as interlayer bonding (302 in previous figures). It is wrapped around the edges of the entire laminate 900 prior to autoclaving and provides further protection against delamination. In this illustration, the edge bonding material 902 is depicted as partially cut away simply to show is relationship to the layers of the laminate.

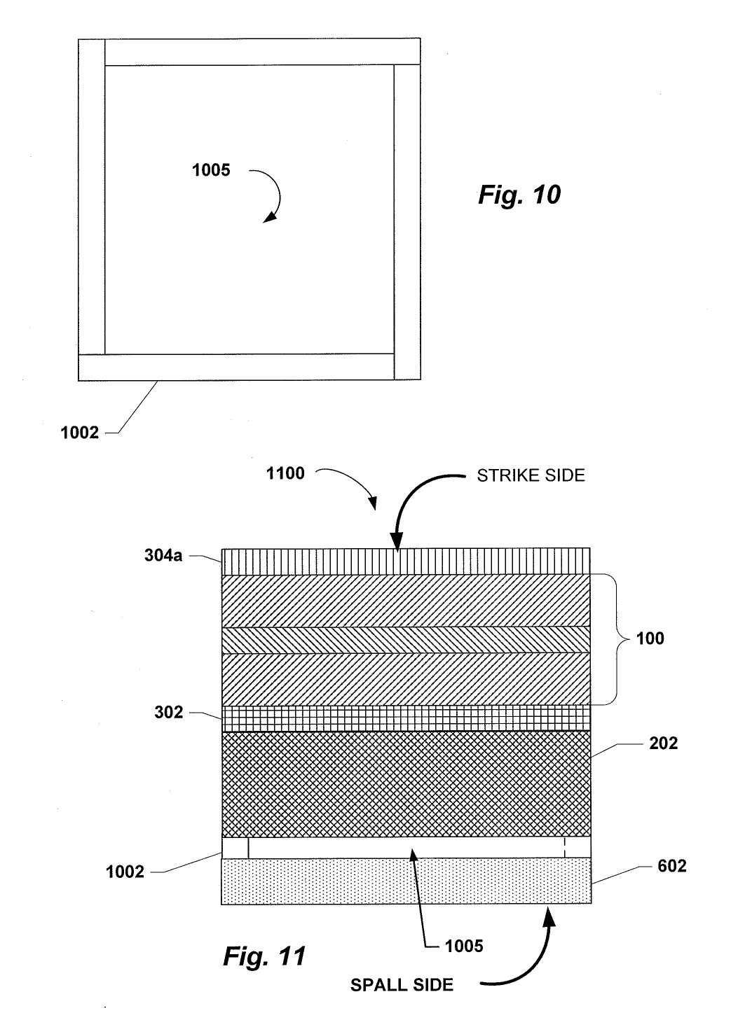

FIGS. 10 and 11 illustrate a further embodiment where an interlayer bonding material is used to create an interlayer frame 1002, the plan view of which in FIG. 10 shows a space 1005 defined in the interior of the frame 1002. The frame 1002 can be used in a laminate assembly as shown in FIG. 11 in which a rigid laminate assembly 100 is bonded to a quasi-thermoset layer 202 with interlayer bonding material 302 as described above. In addition, a polycarbonate layer 602, or other rigid, or semi-rigid layer, is bonded to the quasi-thermoset layer 202 on the spall side with the interlayer frame 1002. The advantage of the this configuration comes when a projectile passes through the quasi-thermoset layer 202 as described above, and the quasi-thermoset is allowed to locally expand into the space 1005 defined by the frame 1002. This permits the quasi-thermoset to absorb energy from the projectile for a longer period of time, thus, slowing the projectile further.

As described above and shown in the associated drawings, the present invention comprises a projectile resistant transparent laminate. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A projectile-resistant transparent laminate comprising:
a rigid laminate assembly having a strike side surface opposing a direction of an anticipated threat, said assembly including first and second rigid transparent lamina bonded together with a transparent, ether-based thermoplastic elastomer layer interposed therebetween, said thermoplastic elastomer layer comprising a transparent polyurethane having an ultra-high modulus of elasticity; and
an energy absorbing assembly bonded to said rigid laminate assembly, said energy absorbing layer including a transparent, quasi-thermoset layer from a cast aliphatic urethane.

2. The laminate of claim 1, wherein said rigid laminate assembly has a thickness of between about 0.25 to about 0.375 inches.

3. The laminate of claim 1, wherein said thermoplastic elastomer layer has a thickness of between about 3 mils to about 10 mils.

4. The laminate of claim 1, wherein said energy absorbing assembly has a thickness of between about 0.093 to about 0.5 inches.

5. The laminate of claim 1, wherein said first and second rigid lamina comprise one of glass, and polycarbonate.

6. The laminate of claim 5, wherein said rigid laminate assembly has a thickness of between about 0.25 to about 0.375 inches, said thermoplastic elastomer layer has a thickness of between about 3 mils to about 10 mils, and said energy absorbing assembly has a thickness of between about 0.093 to about 0.5 inches.

7. The laminate of claim 6, further comprising interlayer bonding material interposed between said rigid laminate assemblies and said energy absorbing assembly.

8. The laminate of claim 6, further comprising a second rigid laminate assembly bonded to said energy absorbing assembly.

9. The laminate of claim 8, further comprising an interlayer bonding material interposed between said first and second rigid laminate assemblies and said energy absorbing assembly.

10. The laminate of claim 9, wherein said interlayer bonding material is comprised of said thermoplastic elastomer.

11. The laminate of claim 9, further comprising a first optical film layer overlaying said strike side surface, said first optical film layer having a thickness of about 11 mils to 21 mils depending upon threat level.

12. The laminate of claim 11, further comprising a second optical film layer overlaying an innermost surface of said structure, said optical film layer having a thickness of about 11 mils to 12 mils depending upon the threat level

13. The laminate of claim 12, further comprising a plurality of energy absorbing assemblies.

14. The laminate of claim 13, wherein said plurality of energy absorbing assemblies are each bonded together with a thermoplastic elastomer.

15. The laminate of claim 1, wherein said rigid laminate assembly includes a non-strike side surface and further comprises a first optical film layer bonded to said strike said surface and a second optical film layer bonded to said non-strike side surface.

16. The laminate of claim 15, wherein said energy absorbing layer further comprises first and second polycarbonate layers bonded to a strike side surface and a non-strike side surface of side surface of said quasi-thermoset layer.

17. The laminate of claim 16, further comprising a layer of glass having first and second optical film layers bonded to strike side and non-strike side surfaces thereof, said glass layer bonded to a non-strike side surface of said second polycarbonate layer.

18. The laminate of claim 17, further comprising a second rigid laminate assembly layered against a non-strike side surface of said energy absorbing assembly, and a polycarbonate layer interposed therebetween.

19. The laminate of claim 18, further comprising a second energy absorbing assembly layered against a strike side surface of said first rigid laminate assembly, and a polycarbonate layer interposed therebetween.

20. The laminate of claim 19, further comprising interlayer bonding material applied to the edges of said laminate.
